(19) United States
(12) Patent Application Publication
(10) Pub. No.: US 2025/0284915 A1
(43) Pub. Date: Sep. 11, 2025

(54) INFORMATION PROCESSING DEVICE TRANSMITTING FINALIZED PRINT DATA TO PRINTER BASED ON ORIGINAL PRINT DATA RECEIVED FROM STANDARD PRINTING SOFTWARE AS RESPONSE TO REQUEST

(71) Applicant: BROTHER KOGYO KABUSHIKI KAISHA, Nagoya (JP)

(72) Inventor: Fumiya KITANO, Nagoya (JP)

(21) Appl. No.: 19/053,046

(22) Filed: Feb. 13, 2025

(30) Foreign Application Priority Data
Mar. 5, 2024 (JP) 2024-033166

(51) Int. Cl. G06K 15/02; G06F 3/12

(52) U.S. Cl. CPC G06K 15/1825; G06F 3/1205; G06F 3/1253; G06F 3/1285

(57) ABSTRACT

An information processing device includes a storage and a processor. The storage stores an information processing program supporting a printer. The processor executing the program receives specified print data from a standard printing software integrated in an operating system. The standard printing software performs a modification process modifying the original print data to size-reduced print data representing a size-reduced image when a size of an original image represented by original print data exceeds a designated sheet size of a printing sheet for printing. The specified print data is the original print data or the size-reduced print data. In response to reception of the specified print data, the processor executing the program transmits, to the standard printing software, a request for the original print data, receive the original print data from the standard printing software, and transmit, to the printer, finalized print data based on the original print data received.

### REFERENCE TO RELATED APPLICATIONS

This application claims priority from Japanese Patent Application No. 2024-033166 filed on Mar. 5, 2024. The entire content of the priority application is incorporated herein by reference.

### BACKGROUND ART

A technology has been disclosed for switching the sheet size setting that has priority between the setting provided in the printer driver and the setting established on the printer body itself when the size of the sheet being printed is indefinite.

### SUMMARY

In recent years, operating systems possessing a function known as a driverless printer function (OS-standard printing software) are becoming more commonplace for printing according to a predetermined printing standard without using a printer driver provided by the vendor of the printer. In such cases, a user can perform printing on the printer without having to install a printer driver.

However, when using the driverless function of the OS-standard printing software described above, the conventional technology can only handle sheet size settings generically and does not support printer-specific settings. For example, one function of the OS-standard printing software may be to reduce the image size of print data automatically when the length of the image specified by the print data exceeds the length set in the sheet size setting for the sheet to be printed.

Now, consider a conceivable case in which the user intends to print on printing sheet of an indefinite length, such as continuous length label sheet. In this conceivable case, assuming the OS-standard printing software does not support a size setting of indefinite length and must always require that some fixed size setting be specified, the software will view the length specified by some print data as exceeding the length of the size setting and will reduce the size of the image to be printed. In such cases, the user cannot obtain the expected printing results.

In view of the foregoing, it is an object of the present disclosure to provide an information processing program and an information processing device that can perform suitable printing on printing sheet of an indefinite length while supporting driverless OS-standard printing software.

In view of the foregoing, it is an object of the present disclosure to provide an image forming apparatus a non-transitory computer readable storage medium storing an information processing program executed by a computer included in an information processing device. The information processing device has an operating system installed thereon. The operating system has standard printing software integrated therein. The standard printing software is configured to perform a modification process when a size of an original image represented by original print data exceeds a designated sheet size of a printing sheet for use in printing the original print data. The modification process includes modifying the original print data to size-reduced print data representing a size-reduced image derived by reducing the size of the original image. The information processing program supports a printer communicable with the information processing device. The information processing program, when executed by the computer, causes the information processing device to perform: receiving specified print data from the standard printing software, the specified print data being one of the original print data and the size-reduced print data; in response to reception of the specified print data, transmitting, to the standard printing software, a request for the original print data; receiving the original print data from the standard printing software as a response to the request; and transmitting, to the printer, finalized print data based on the original print data received as the response to the request.

In order to attain the above and other objects, the present disclosure provides an information processing device. The information processing device includes a communication interface communicable with a printer, a storage, and a processor. an information processing program supporting the printer and stored in the storage, when executed by the processor, causes the processor to perform: receiving specified print data from a standard printing software, the standard printing software integrated in an operating system installed on the information processing device, wherein the standard printing software is configured to perform a modification process when a size of an original image represented by original print data exceeds a designated sheet size of a printing sheet for use in printing the original print data, wherein the modification process includes modifying the original print data to size-reduced print data representing a size-reduced image derived by reducing the size of the original image, the specified print data being one of the original print data and the size-reduced print data; in response to reception of the specified print data, transmitting, to the standard printing software, a request for the original print data; receiving the original print data from the standard printing software as a response to the request; and transmitting, to the printer through the communication interface, finalized print data based on the original print data received as the response to the request.

In the above structures, suitable printing on indefinite length printing sheet can be performed using the OS-standard printing software without using a printer driver.

### BRIEF DESCRIPTION OF DRAWINGS

FIG. 1 is a block diagram illustrating a functional configuration of a printing system including a printer and a terminal device.

FIG. 2 is a flowchart illustrating a control procedure according to a comparative example performed by an editing application, CUPS, printer application, and printer work in conjunction with each other.

FIG. 3 is a flowchart illustrating a control procedure according to an embodiment performed by an editing application, CUPS, printer application, and printer work in conjunction with each other.

FIG. 4 is a flowchart illustrating a control procedure according to a variation (1) performed by an editing application, CUPS, printer application, and printer work in conjunction with each other.

FIG. 5 is a flowchart illustrating a control procedure according to a variation (2) performed by an editing application, CUPS, printer application, and printer work in conjunction with each other.

FIG. 6 is a flowchart illustrating a control procedure according to a variation (3) performed by an editing application, CUPS, printer application, and printer work in conjunction with each other.

FIG. 7 is a block diagram illustrating a hardware configuration of the printing system.

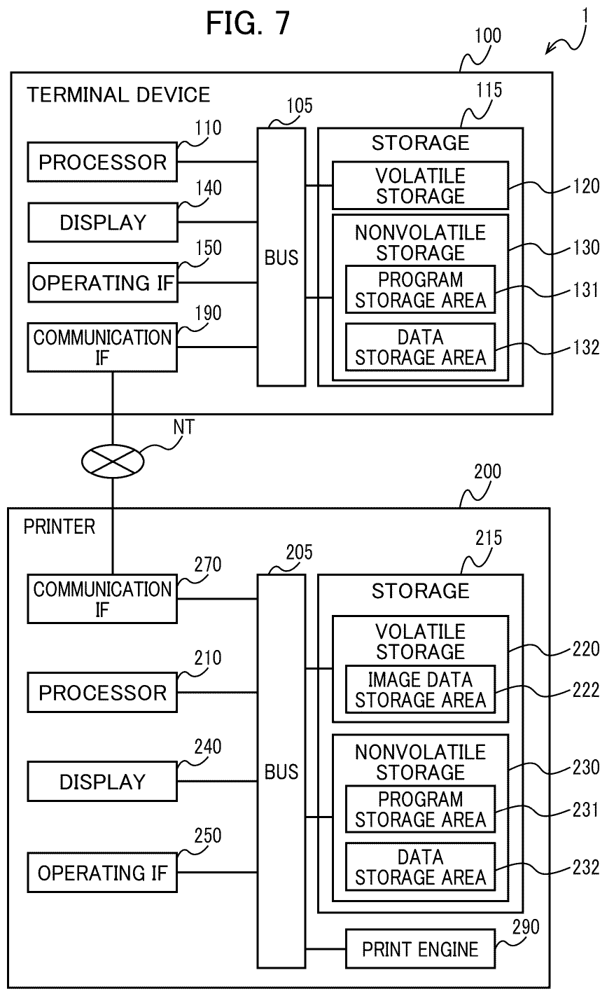

### DESCRIPTION

### Embodiment

An embodiment of the present disclosure will be described while referring to the accompanying drawings.

### Overview of a Printing System

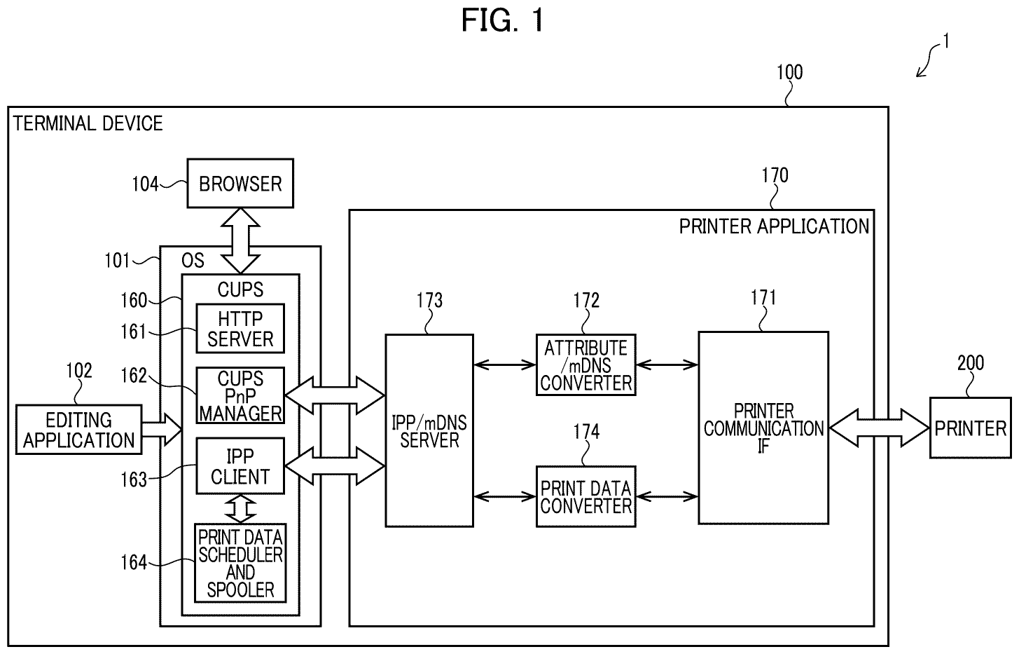

FIG. 1 shows a sample configuration of a printing system 1 according to the present embodiment. In FIG. 1, the printing system 1 has a terminal device 100, and a printer 200. The terminal device 100 and printer 200 are connected and can communicate with each other via an internet, wired LAN, or wireless LAN, for example. The terminal device 100 is an example of the information processing device. The printer 200 is an example of the printer or printing device.

### Functional Configuration of the Terminal Device

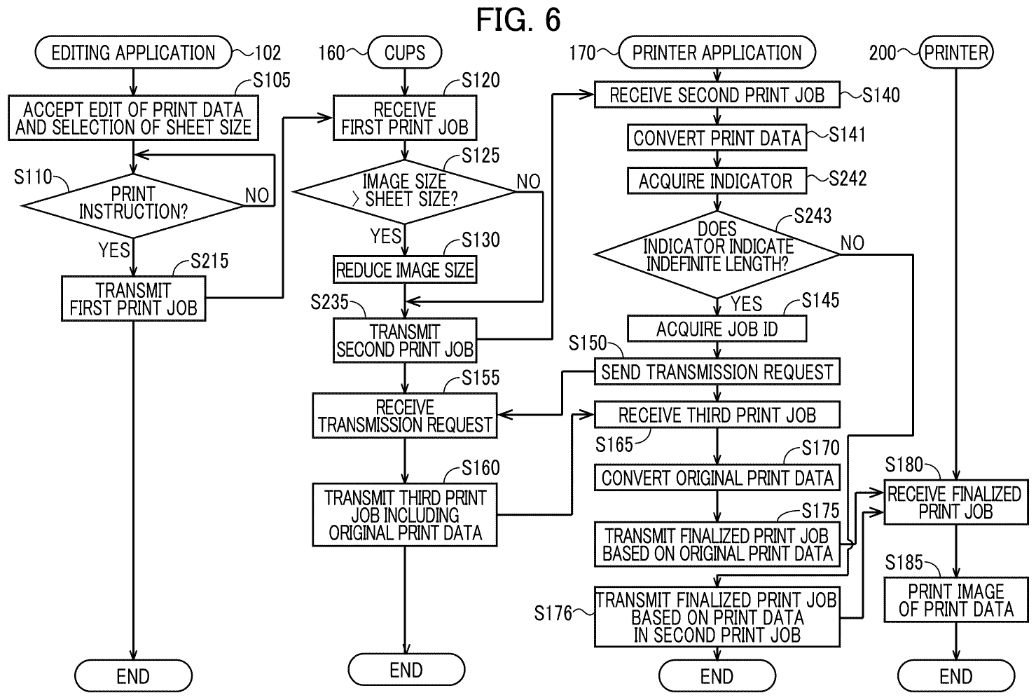

The terminal device 100 sends print data to the printer 200 to execute printing. The terminal device 100 is a desktop PC, a laptop, or a tablet computer, for example, but may also be a smartphone or other portable terminal. While described later in detail (see FIG. 6), the terminal device 100 has a processor 110, and a storage 115 storing various printing-related programs. With the processor 110 configured to execute the various printing-related programs stored in the storage 115, the terminal device 100 has the functional configuration shown in FIG. 1.

As shown in FIG. 1, the terminal device 100 has an operating system (OS) 101, an editing application 102, a printer application 170, and a browser 104. The OS 101 has a function known as a driverless printing function for printing according to a predetermined printing standard without using a printer driver provided by the vendor of the printer.

In this example, the OS 101 possesses the Common Unix Printing System (CUPS) 160, which is an OS modular printing system. The OS 101 is an example of an operating system and the CUPS 160 is an example of the OS-standard printing software or the standard printing software integrated in the OS and an example of the software built into the OS (the OS built-in software).

### CUPS

The CUPS 160 includes an HTTP server 161, a CUPS PnP manager 162, an IPP client 163, and a print data scheduler and spooler 164.

The HTTP server 161 is server software that runs on the CUPS 160. The HTTP server 161 uses the Hypertext Transfer Protocol (HTTP) to acquire and provide information and functions through the browser 104. The CUPS PnP manager 162 has a plug and play (PnP) function for creating printer queues by detecting printers (including virtual printing devices) using a protocol such as multicast Domain Name System Service Discovery (mDNS-SD) and registering them in the CUPS 160.

The configuration of the CUPS PnP manager 162 is modified according to a script executed when the printer application 170 is installed in order that addresses searched using PnP are restricted to the internal network of the terminal device 100 (normally IP address 127.0.0.1). Accordingly, the CUPS 160 cannot directly recognize the printer 200 but can recognize the printer application 170 as a printer. The printer application 170 is not an actual printer but is known as a virtual printer that behaves as a printer to the CUPS 160. The printer application 170 acts as an intermediary between the CUPS 160 and printer 200 and facilitates printing using the CUPS 160 and printer 200. The printer application 170 is an example of the virtual printer or virtual printing device.

The IPP client 163 exchanges print data and attributes with an IPP/mDNS server 173 described later using the Internet Printing Protocol (IPP).

The print data scheduler and spooler 164 manages print jobs received from the editing application 102 and the like. The print data scheduler and spooler 164 manages a plurality of print jobs generated simultaneously by temporarily queuing and sequentially processing the print jobs before transferring them to the IPP client 163.

### Printer Application

The printer application 170 can be registered in the CUPS 160 as a virtual printer supporting the printer 200 connected to the terminal device 100. The CUPS 160 treats the printer application 170 as a virtual printer to execute various processes related to printing. These processes include a capability information acquisition process and a print data transmission process, for example. The printer application 170 includes a printer communication interface (IF) 171, an attribute/mDNS converter 172, an IPP/mDNS server 173, and a print data converter 174. The printer application 170 is an example of the information processing program.

The printer communication interface 171 communicates with the printer 200 using the IPP protocol. The printer communication interface 171 receives attributes from the printer 200 and transmits print data to the printer 200.

The attribute/mDNS converter 172 acquires attributes representing capabilities of the printer 200 via the printer communication interface 171. The attribute/mDNS converter 172 converts the attributes acquired from the printer 200 to attributes corresponding to printing functions that the CUPS 160 supports.

The attribute/mDNS converter 172 has a multicast Domain Name System (mDNS) function. The mDNS sends DNS queries within the local network as an Internet Protocol (IP) multicast to query all devices on the same network simultaneously. When receiving a query, devices on the network respond by sending their own IP address.

The IPP/mDNS server 173 outputs the attributes converted by the attribute/mDNS converter 172 to the CUPS 160 as part of the capability information acquisition process performed by the CUPS 160. The CUPS 160 outputs to the IPP/mDNS server 173 print data corresponding to the attributes converted by the IPP client 163. The CUPS 160 transmits to the IPP/mDNS server 173 the print data corresponding to the converted attributes in the print data transmission process. Then, the IPP/mDNS server 173 acquires from the CUPS 160 the print data corresponding to the converted attributes, and outputs this print data to the print data converter 174. The IPP/mDNS server 173 has an mDNS function similar to the attribute/mDNS converter 172.

The print data converter 174 acquires print data from the CUPS 160 via the IPP/mDNS server 173. The print data converter 174 converts the print data acquired from the CUPS 160 to print data supported by the printing function of the printer 200. The print data converter 174 outputs the converted print data to the printer communication interface 171.

The printer communication interface 171 transmits print data outputted from the print data converter 174 to the printer 200.

### Printer

The printer 200 prints on printing sheets (or papers) based on print jobs received from the printer communication interface 171 of the terminal device 100. The printer 200 uses sheet of an indefinite length as printing sheet (or printing paper). Here, the sheet of indefinite length is a sheet having a size having a definite length in one of horizontal and vertical directions. The printer 200 is a printing device that supports printing sheet of an indefinite length. For example, the printer 200 is a label printer that prints on continuous length sheet wound in a roll to create printed labels. However, the printer 200 may be a printing device other than a label printer that supports printing sheet of an indefinite length.

### Features of the Embodiment

After editing print data with the editing application 102, the user also sets the size of printing sheet (sheet size) and issues an instruction to execute a print. Hereinafter, the size of image or sheet has a vertical length (or a vertical dimension) and a horizontal length (or a horizontal dimension). Here, the vertical dimension of the image specified in the print data may be called the height while the horizontal dimension may be called the width. When the user is attempting to print on printing sheet of an indefinite length, such as continuous length label sheet (or paper), the user sets a sheet size corresponding to the indefinite length type of sheets (or papers). The sheet size of the indefinite length type of sheets has a definite dimension in one of the vertical and horizontal dimensions and an indefinite dimension in remaining one of the vertical and horizontal dimensions. However, the CUPS 160 may not support an indefinite length size setting and may require that a size setting of some type of definite length (fixed length) settings, such as prescribed sizes of die-cut labels, A3, A4, and letter, must be specified. When the user selects the size of indefinite length type of sheet, the editing application 102 changes the user selected size to an acceptable size that the CUPS 160 can recognize, and transmits the acceptable size to the CUPS 160. For example, the user selects a size having 26 mm height×indefinite width, the editing application 102 changes this size to an acceptable size of 26 mm height×100 mm width by replacing the indefinite width with a predetermined definite dimension (100 mm in this example). Thereafter, the editing application 102 sends to the acceptable size having 26 mm height×100 mm width to the CUPS 160. In such cases, the size of the image specified in the print data may exceed the selected size of the printing sheet. Hereinafter, the size, length, and dimensions of the image specified in the print data is simply referred to as the size, length, and dimensions specified in the print data. When the size specified in the print data exceeds the size of the printing sheet, the CUPS 160 may perform a function to reduce the size of image by modifying the print data automatically. Reducing the size of image by modifying the print data may be referred to reducing the print data in dimensions. When print data is reduced in dimensions by such a function of the CUPS 160, the user may not obtain the expected printing results because the actual sheet size has indefinite length and reducing the print data in dimensions is not necessary.

Hereinafter, the sheet size of indefinite length may be referred to as the indefinite sheet size or the indefinite size, and the sheet size that is not the indefinite sheet size and thus has definite dimensions in vertical and horizontal directions may be referred to the definite sheet size or the definite size.

Therefore, to account for a possibility that the actual sheet size for sheet to be printed is a size having indefinite length, the printing system 1 of the present embodiment performs printing based on the original print data outputted from the editing application 102 and saved in the CUPS 160 instead of the print data that the CUPS 160 has outputted intended for printing. The CUPS 160 in the present embodiment has specifications that do not support an indefinite length size setting and requires that some size setting of the definite sizes (fixed sizes) be specified. Hence, it is possible that the user intended to specify indefinite length, even when some other size setting has been made. For this reason, the printing system 1 of the present embodiment performs printing based on the original print data instead of the print data outputted from the CUPS 160 intended for printing, regardless of the sheet size setting specified by the user. As a result, the printing system 1 can perform suitable printing for indefinite length printing sheet and can create printed matter with content in line with the user's intentions and without any size reductions in dimensions not intended by the user. This process is described below in detail.

### Control Procedure

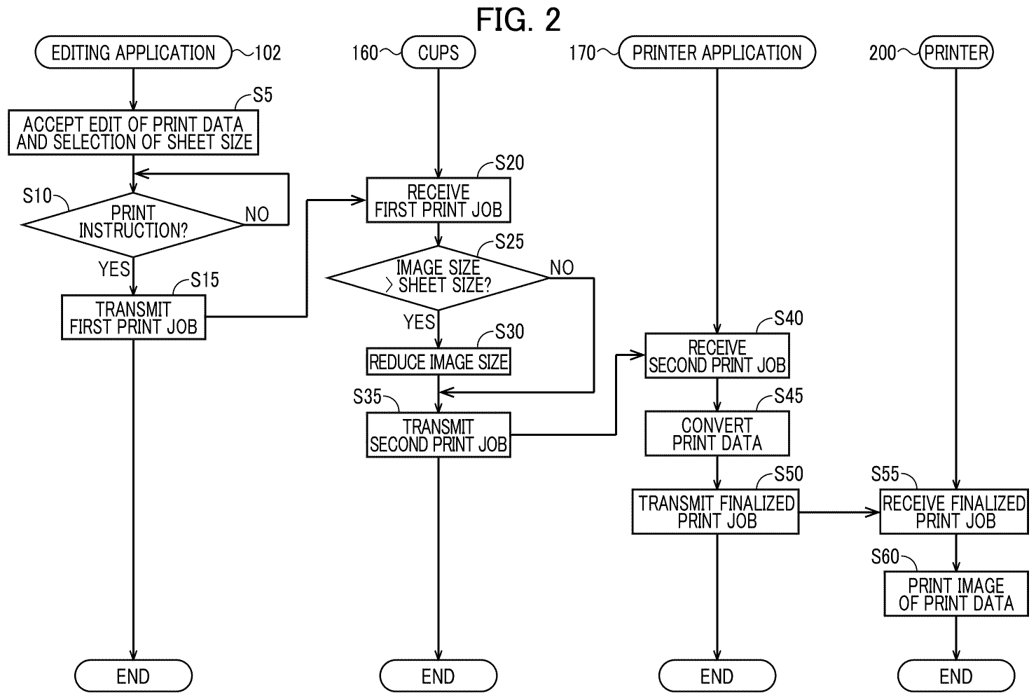

First, a comparative example in which printing is not performed based on the original print data will be described according to the flowchart in FIG. 2 as a comparison to the present embodiment. The editing application 102, CUPS 160, printer application 170, and printer 200 work in conjunction with each other to execute the control procedure in this comparative example.

First, in S5 of FIG. 2 the editing application 102 accepts user operations for editing print data and selecting a size for the printing sheet. For the size selection, the editing application 102 offers, as options, a plurality of sizes including 26×51 mm, 26×76 mm, and 50×102 mm, and the user selects one of these sizes. The editing application 102 also offers one or more options each indicating a sheet size having indefinite length. The options may be provided in various formats including: actual size dimensions “26 mm height×51 mm width” or “26 mm × indefinite width”; identifiers or names such as “A4” or “continuous label sheet”; and graphical representations or images depicting the sheet sizes. For indicating the sheet size of definite length x indefinite length, such as “26 mm×indefinite width”, the only one definite dimension of two dimensions, such as “26 mm” may be presented as the option. In other words, the option specifying only one definite dimension (such as “26 mm”) may be identifier indicating that the sheet size is of indefinite type.

As described above, when the user selects an option indicating a sheet size having indefinite length, such as 26 mm height×indefinite width, the editing application 102 changes this sheet size to an available sheet size, such as 26 mm height×100 mm width, by replacing an indefinite dimension of the user selected sheet size with the predetermined definite dimension such as 100 mm.

In S10 the editing application 102 determines whether the user has issued an instruction to execute a print. The editing application 102 repeats the determination in S10 while an instruction to print has not been received (S10: NO). When the user has issued an instruction to execute a print (S10: YES), the process advances to S15.

In S15 the editing application 102 transmits a first print job to the CUPS 160. The first print job includes the print data edited in S5, sheet size information, a job ID, and the like. The sheet size information included in the first print job indicates the user selected sheet size selected in S5 when the user selected sheet size indicates the definite size of sheet that has definite dimensions in the vertical and horizontal dimension. However, the sheet size information indicates the available sheet size that the editing application 102 generates based on the user selected sheet size when the user selected sheet size indicates the sheet size of indefinite length.

In S20 the CUPS 160 receives the first print job generated and sent by the editing application 102. The CUPS 160 saves the first print job in a suitable storage area of the storage 115 (see FIG. 6).

In S25 the CUPS 160 determines whether the size of the image specified in the print data contained in the first print job received in S20 exceeds the sheet size specified by the sheet size information in the received first print job. When each of vertical and horizontal dimensions specified in the print data is within the corresponding dimension of the sheet size (S25: NO), the CUPS 160 advances to S35 described later. However, when at least one of the vertical and horizontal dimensions specified in the print data are greater than the corresponding dimension of the sheet size (S25: YES), the CUPS 160 advances to S30 described below.

In S30 the CUPS 160 reduces the size of the image of the print data based on the first print job received in S20 to a size that fits within the specified size for the printing sheet. Specifically, the CUPS 160 modifies the print data so that both vertical and horizontal dimensions of the image represented by the print data can fit within the corresponding dimensions of the printing sheet by reducing the dimensions of the image while maintaining a constant aspect ratio of the image.

When the CUPS 160 has reached a NO determination in S25, in S35 the CUPS 160 transmits a second print job to the printer application 170 based on the print data received in S20, i.e., print data that has not been reduced in dimensions. The second print job in this case (S25: NO) includes the print data received in S20, and the sheet size information and job ID included in the first print job. When the CUPS 160 reached a YES determination in S25, the CUPS 160 transmits the second print job to the printer application 170 based on the modified print data whose image has the reduced size as a result of the process of S30. That is, the second print job in this case (S25: YES) includes the modified print data as a result of S30, and the sheet size information and job ID included in the first print job.

As a specific example, when 50 mm width×102 mm height has been selected as the size of the printing sheet and 50 mm width×100 mm height is the image size specified in the print data, the CUPS 160 transmits a second print job to the printer application 170 based on print data of the original size. On the other hand, when the size specified in the print data is 50 mm width×200 mm height with the same size (50 mm width×102 mm height) of the printing sheet selected, the CUPS 160 reduces the size of the image in the print data from a 200 mm height to a 102 mm height while maintaining the aspect ratio and transmits a second print job to the printer application 170 based on the modified print data that has been reduced in dimensions. In this case, the width specified in the print data is also reduced to about one half. As another example, when the size specified in the print data is 100 mm width×100 mm height with the same size (50 mm width×102 mm height) of the printing sheet selected, the CUPS 160 reduces the size of the image in the print data from a 100 mm width to a 50 mm width while maintaining the aspect ratio and transmits a second print job to the printer application 170 based on the print data that has been reduced in dimensions. In this case, the height of the print data is also reduced to one half.

In S40 the printer application 170 receives the second print job from the CUPS 160.

In S45 the printer application 170 converts the print data included in the second print job received in S40 to print data supported by the printing function of the printer 200. For example, the print data converter 174 of the printer application 170 performs rasterization to convert the print data from vector data to raster data.

In S50 the printer application 170 transmits a finalized print job to the printer 200 based on the print data converted in S45. The finalized print job includes the print data converted in S45, the sheet size information, the job ID, and the like.

In S55 the printer 200 receives the finalized print job generated by the printer application 170.

In S60 the printer 200 prints the print data based on the finalized print job received in S55. This completes the procedure shown in the flowchart of FIG. 2.

In the comparative example described above, the CUPS 160 reduces the size of the image of the print data when the size specified in the print data is greater than the selected size of the printing sheet. Since the printer application 170 controls the printer 200 to print based on this print data that has been reduced in dimensions, the user may not obtain desired printing results.

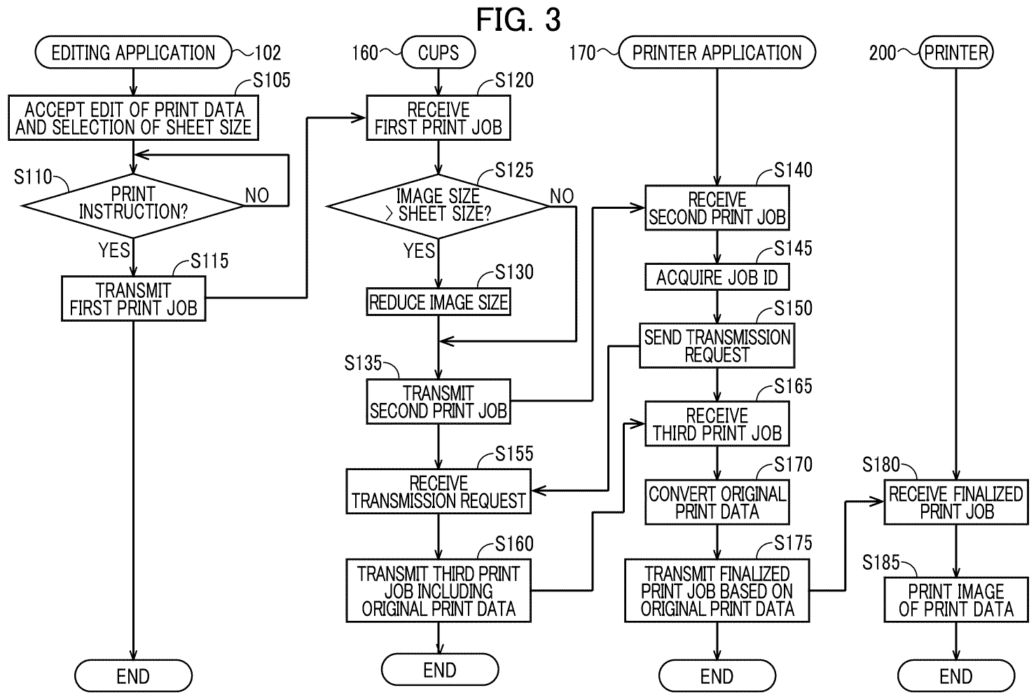

Next, a control procedure according to the present embodiment will be described with reference to the flowchart in FIG. 3. The editing application 102, CUPS 160, printer application 170, and printer 200 work in conjunction with each other to execute this control procedure.

In S105 of FIG. 3, first the editing application 102 accepts user operations to edit print data and to select the size of the sheet to be printed. S105 is performed similarly to S5. Specifically, when the user selects an option indicating a sheet size having indefinite length, such as 26 mm height×indefinite width, the editing application 102 changes this sheet size to an available sheet size, such as 26 mm height×100 mm width, by replacing an indefinite dimension of the user selected sheet size with the predetermined definite dimension such as 100 mm.

In S110 the editing application 102 determines whether the user issued an instruction to execute a print. The editing application 102 repeats the determination in S110 while an instruction to print has not been received (S110: NO). When an instruction to execute a print is received (S110: YES), the process advances to S115.

In S115 the editing application 102 transmits a first print job to the CUPS 160. The first print job includes the print data edited in S105, and sheet size information and the job ID. Similarly to S15, the sheet size information included in the first print job indicates the user selected sheet size is the sheet size selected in S5 when the user selected sheet size indicates the definite size of sheet that has definite dimensions in the vertical and horizontal dimension. However, the sheet size information indicates the available sheet size that the editing application 102 generates based on the user selected sheet size when the user selected sheet size indicates the sheet size of indefinite length.

In S120 the CUPS 160 receives the first print job generated by the editing application 102. The CUPS 160 extracts the print data from the first print job received in S120 and saves this print data in a suitable storage area of the storage 115. In this case, the CUPS 160 may save the print data in association with the job ID in the first print job in the storage area. In this embodiment, the print data extracted and saved in a storage area in S120 will be called the “original print data” for convenience. In S120 the CUPS 160 may save the first print job exactly as received in the storage 115.

In S125 the CUPS 160 determines whether the size of the image represented by the print data generated above in S120 exceeds the sheet size specified by the sheet size information in the received first print job. When each of the height and width specified in the print data is within a corresponding one of the height and width of the sheet size (S125: NO), the CUPS 160 advances to S135 described later. On the other hand, when at least one of the length and width specified in the print data is greater than a corresponding one of the length and width of the sheet size (S125: YES), the CUPS 160 advances to S130 described next.

In S130 the CUPS 160 modifies the print data generated in S120 to a size that fits within the selected size of the printing sheet. At this time, the CUPS 160 modifies the print data so that each of the length and width dimensions can fit within a corresponding one of the length and width of the printing sheet while maintaining a constant aspect ratio. The print data modified in S130 is an example of the size-reduced print data. The size or dimensions of the image represented in the print data may be determined by the number of pixels in each of the vertical and horizontal directions and resolution specifying the number of pixels that appears in a unit length such as dot per inch (DPI). The information on the resolution may be included in the print data. Alternatively, the information on the resolution may be included in a print job including the print data. In S130, the CUPS 160 may modify print data by reducing the numbers of pixel in each of the vertical and horizontal directions and/or increasing the resolution in each of the vertical and horizontal directions.

When the CUPS 160 reached a NO determination in S125, in S135 the CUPS 160 transmits a second print job to the printer application 170 based on the print data generated in S120, i.e., print data that has not been reduced in dimensions. The second print job in this case (S125: NO) includes the print data extracted in S120, and the sheet size information and job ID included in the first print job. On the other hand, when the CUPS 160 reached a YES determination in S125, in S135 the CUPS 160 transmits a second print job to the printer application 170 based on the print data reduced in dimensions in S130. The second print job in this case (S125: YES) includes the modified print data modified in S130 to represent the image having the reduced size, and sheet size information and job ID included in the first print job.

In S140 the printer application 170 receives the second print job generated by the CUPS 160. The print data included in the second print job is an example of the specified print data.

In S145 the printer application 170 extracts the job ID contained in the second print job received in S140.

In S150 the printer application 170 sends a transmission request to the CUPS 160 requesting the CUPS 160 to transmit the original print data based on the job ID acquired in S145. The job ID serves to identify the original print data, which is the subject of the transmission request. The process of step S150 is executed upon reception of the second print job in S140. In other words, the printer application 170 sends a transmission request for the original print data regardless of what size of printing sheet has been designated by the sheet size information in the second print job. The printer application 170 is designed in advance to have access privileges for requesting the CUPS 160 to transmit original print data. The transmission request is an example of the request.

In S155 the CUPS 160 receives the transmission request for the original print data from the printer application 170.

In S160 the CUPS 160 reads, from the storage 115, the original print data identified by the job ID in the transmission request received from the printer application 170 and transmits a third print job including the read print data to the printer application 170. Here, the third print job includes the original print data that has been saved in a storage area in S120, and the sheet size information and job ID included in the second print job and job ID the same as the job ID included in the transmission request.

In S165 the printer application 170 receives the third print job containing the original print data from the CUPS 160 in response to the transmission request sent in S150. The receiving the third print job is an example of the receiving the original print data.

In S170 the printer application 170 converts the original print data contained in the print job received in S165 to print data supported by the printing function of the printer 200. As in S45 in FIG. 2, in S170 the printer application 170 performs rasterization to convert the print data from vector data to raster data, for example. In S170 the printer 170 converts the original print data in such a manner that the size of the image in the converted print data is unchanged and thus is the same as the size of the image in the original print data. The process of S165 is an example of the original data acquisition process.

In S175 the printer application 170 transmits a finalized print job based on the original print data acquired in S165 and converted in S170 to the printer 200. The finalized print job includes the original print data acquired in S165 and converted in S170, and sheet size information and job ID. The finalized print job may not include the sheet size information. The original print data transmitted in S170 is an example of the finalized print data, and the process of S175 is an example of the transmitting the finalized print data.

In S180 the printer 200 receives the finalized print job generated and sent by the printer application 170.

In S185 the printer 200 prints the print data based on the finalized print job received in S180. This completes the process in the flowchart of FIG. 3. The printer 200 may not reference the sheet size information included in the finalized print job, and perform the printing based on a sheet installed in the printer 200.

The printer 200 may have a function to modify the print data included in the finalized print job so that the image represented in the print job is reduced in dimensions. For example, when the finalized print job includes the original print data and the size of the image specified in the original print data exceeds the size of the printing sheet, the printer 200 may modify the print data so that the reduced size of the image can fit the size of the printing sheet. In this reduction process, when the size of the sheet that the printer 200 uses has an indefinite dimension, the printer 200 considers this indefinite dimension. That is, when the size of the sheet to be used has an indefinite dimension in one of the horizontal and vertical direction and a definite dimension in a remaining one of the horizontal and vertical directions, the printer 200 determines whether the dimension specified in the print data in the remaining one of the horizontal and vertical directions exceeds the corresponding dimension of the sheet to be used, and performs the reduction process when and only when the dimension specified in the print data in the remaining one of the horizontal and vertical directions exceeds the corresponding size of the sheet to be used.

### Effects of the Embodiment

In the embodiment described above, the printer application 170 executes the process of S140 to acquire print data generated and outputted by the CUPS 160. The CUPS 160 has a function for reducing the size of the image in the print data when the size of the image represented by the print data exceeds the size of the printing sheet. In S140 the printer application 170 acquires either print data that has not undergone such reduction in dimensions or print data that has undergone a reduction in dimensions.

To account for a possibility that the sheet to be printed is of indefinite length, the printer application 170 executes the processes of S150 and S165 upon acquiring the print data in S140. In S150 the printer application 170 outputs a request to the CUPS 160 requesting the transmission of the original print data. In S165 the printer application 170 newly acquires the original print data outputted from the CUPS 160 in response to the transmission request. In S175 the printer application 170 sends the finalized print job to the printer 200 based on the original print data acquired in S165.

Thus, when printing on printing sheet of indefinite length in the present embodiment, the printer application 170 does not use the print data obtained in S140, which may have been reduced in dimensions, but ultimately uses the original print data acquired in S165 as the finalized print data. As a result, the terminal device 100 of this embodiment can perform suitable printing on indefinite length printing sheet to create printed matter whose content is in line with the user's intention and that has not been reduced in dimensions against the wishes of the user.

A particular feature of this embodiment is that the printer application 170 executes steps S150 and S165 no matter what selection has been made for the size of the printing sheet. Ultimately, the printer application 170 always uses, the finalized print data, the original print data acquired in S165 rather than the print data acquired in S140. Thus, the terminal device 100 according to this embodiment can reliably perform printing suitable for indefinite length printing sheet.

Another feature of the present embodiment is that the printer application 170 is registered in the CUPS 160 as a virtual printer. By registering the printer application 170 as a virtual printer, the CUPS 160 can output print data to the printer application 170, and the printer application 170 can control the printer 200 to perform a print based on that print data.

Another feature of the present embodiment is that in S175 the printer application 170 transmits print data to the printer 200, which is a label printer that creates printed labels by printing on a continuous sheet of printing sheet wound into a roll. Since a label printer creates printed labels using continuous printing sheet from a roll, for example, indefinite length is selected as the size of the printing sheet. Accordingly, when creating printed labels in this embodiment, the printer application 170 does not use the print data obtained in S140 but ultimately uses the original print data acquired in S165. As a result, the printing system 1 according to this embodiment can perform suitable printing on a label printer by creating printed labels having content in line with the user's expectations and without any reduction in dimensions not in accordance with the user's wishes.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below:

### (1) Using Original Print Data Only in Place of Print Data That Has Been Reduced in Dimensions

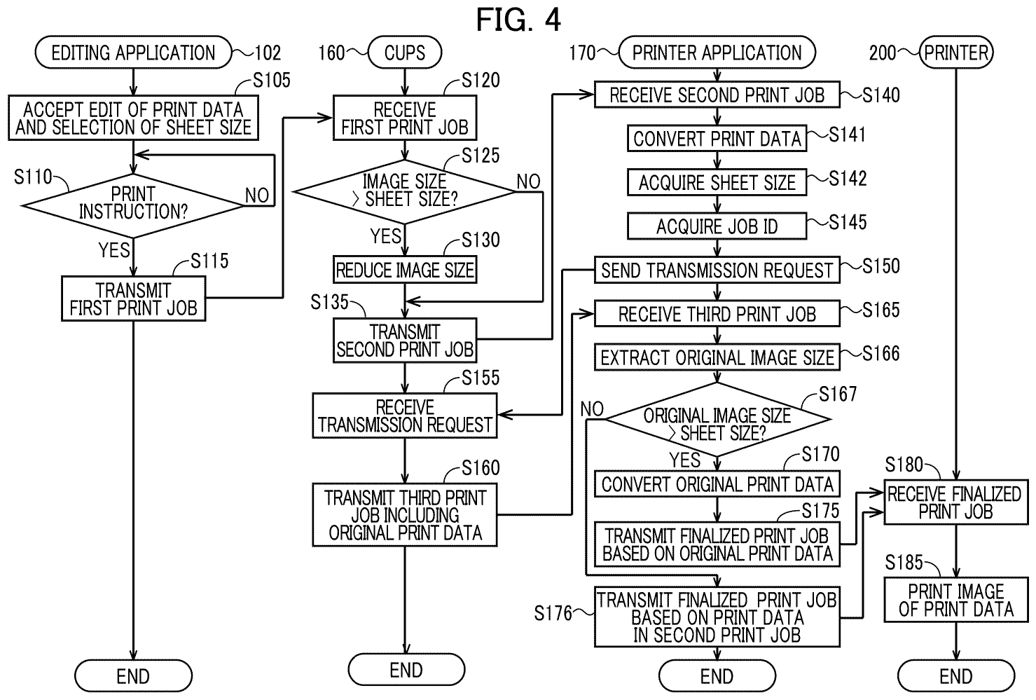

In the above embodiment, the printer application 170 obtains the original print data and uses this data in place of the print data to execute a print, regardless of what sheet size has been designated in the acquired second print job, i.e., regardless of whether the print data has been reduced in dimensions by the CUPS 160. In this case, the original print data is acquired and used in place of the print data even when the print data has not been reduced in dimensions by the CUPS 160 and can be used as is. In this variation, the printer application 170 may replace print data with the original print data so that printing is performed based on the original print data, only when the print data has been reduced in dimensions by the CUPS 160. Steps in the control procedure of this variation will be described next with reference to the flowchart in FIG. 4, wherein steps similar to those of FIG. 3 described above are designated with the same step numbers to avoid duplicating description.

Steps S105-S140 of FIG. 4 are identical to those in FIG. 3, and a description of these steps will not be repeated here.

In S141 the printer application 170 converts the print data contained in the second print job received in S140 to print data supported by the printing function of the printer 200. The printer application 170 converts the print data in S141 in the same manner as S170 shown in FIG. 3.

In S142 the printer application 170 acquires the sheet size from the sheet size information in the second print job received in S140. The process of S142 is an example of the acquiring the designated sheet size.

Subsequent steps S145-S165 are identical to those in FIG. 3, and a description of these steps will be simplified. That is, the printer application 170 sends a transmission request to the CUPS 160 in S150 for the original print data, regardless of the size selection results obtained in S142, and receives the third print job containing the original print data in S165.

In S166 the printer application 170 extracts the size of the image represented by the original print data included in the print job received in S165.

In S167 the printer application 170 determines whether the size specified in the original print data exceeds the size of the printing sheet based on the size specified in the original print data extracted in S166 and the size of the printing sheet acquired in S142. Since the determination in S167 is based on data that is essentially identical to the data used in S125, the determination in S167 produces the same result as in S125. When the printer application 170 determines that the size specified in the original print data exceeds the size of the printing sheet (S167: YES), the process advances to step S170. The process of S167 is an example of the determining whether the size of the original image represented by the original print data exceeds the designated sheet size.

Steps S170 and S175 are identical to those in FIG. 3, and a description of these steps will be simplified. That is, when the printer application 170 determines in S167 that the size of the original print data is larger than the size of the printing sheet, in S175 the printer application 170 transmits the finalized print job to the printer 200 based on the original print data acquired in S165.

On the other hand, when the printer application 170 determines in S167 that the size specified in the original print data is no greater than the size of the printing sheet (S167: NO), the process advances to S176.

In S176 the printer application 170 transmits a finalized print job to the printer 200 based on the print data acquired in S140 and converted in S141. In other words, when the printer application 170 reaches a NO determination in S167, the print data received in S140 can be used since the print data has not reduced in dimensions by the CUPS 160. The finalized print job transmitted to the printer 200 includes the print data that has been acquired in S140 and converted in S141, and sheet size information and job ID included in the second print job. The print data transmitted in S176 is an example of the finalized print data based on the original print data received. The process of S176 is an example of the transmitting the finalized print data. The process of S141 may not be performed between S140 and S142, and may be performed after a NO determination is made in S167 and before performing S176.

In S180 the printer 200 receives the finalized print job transmitted from the printer application 170 in S175 or step S176.

In S185 the printer 200 performs a print of the print data based on the finalized print job received in S180. This completes the process in the flowchart of FIG. 4.

In this variation, the printer application 170 executes steps S150 and S165 no matter what sheet size is designated in the sheet size information in the second print job. Subsequently, the printer application 170 executes the determination in S167 on the original print data obtained in S165. When the size of the image represented by the original print data exceeds the size of the printing sheet, the printer application 170 does not include the print data acquired in S140 in the finalized print job but includes the original print data obtained in S165 in the finalized print job.

The printing system 1 according to this variation can reliably execute printing suitable for indefinite length printing sheet.

### (2) Acquiring the Original Print Data Only When Indefinite Length Has Been Selected by the User

Similarly to the above embodiment, in this variation, when the user selects an option indicating a sheet size having indefinite length, such as 26 mm height×indefinite width, the editing application 102 changes this sheet size to an available sheet size, such as 26 mm height×100 mm width, by replacing an indefinite dimension of the user selected sheet size with the predetermined definite dimension such as 100 mm. This predetermined definite dimension (100 mm for example) is transferred from the editing application 102 to the printer application 170 as part of the print job. In this variation, the printer application 170 recognizes the predetermined definite dimension as an indicator of the indefinite dimension. That is, when the printer application 170 receives the sheet size information indicating a sheet size having the predetermined definite dimension, the printer application 170 recognizes that the actual sheet size that the user has selected has an indefinite dimension. In other words, the predetermined definite dimension signifies that the dimension of the sheet size that the user has selected is actually the indefinite dimension. Put another way, the predetermined definite dimension is a dimension associated with the indefinite dimension. One or more predetermined definite dimensions may be registered in the storage 115 so as to specify that these predetermined definite dimensions are indicators of the indefinite dimension. The editing application 102 may refer to these predetermined definite dimensions in the storage 115 when generating the available size. The printer application 170 may refer to these the predetermined definite dimensions in the storage 115 when determining whether one dimension of the sheet size included the sheet size information matches the predetermined definite dimension to signify the actually-selected sheet size has indefinite dimension.

In this variation, the printer application 170 is configured to acquire the original print data only when the sheet size in the received sheet size information has a predetermined definite dimension signifying that the actually selected sheet size has an infinite dimension.

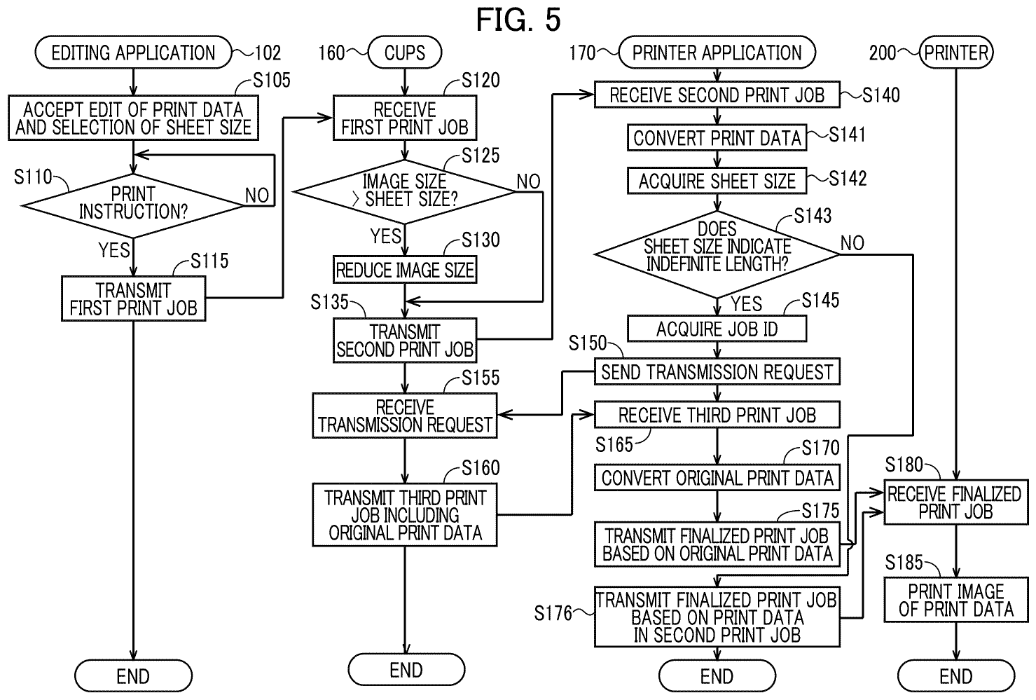

Steps in a control procedure of this variation will be described with reference to the flowchart in FIG. 5, wherein steps similar to those in FIG. 4 have been designated with the same step numbers to avoid duplicating description.

Steps S120-142 are identical those in FIG. 4, and a description of these steps has been omitted.

In S143 the printer application 170 determines whether that the sheet size selected by the user through the editing application 102 has an indefinite length. Specifically, the printer application 170 determines whether the sheet size acquired in S142 has the predetermined definite dimension signifying indefinite length. In other words, in S143 the printer application 170 determines whether one of the dimensions in the acquired sheet size from the sheet size information is an indicator indicating that the actually-selected sheet size has an indefinite dimension. When the sheet size indicated in the sheet size information in the second print job received in S140 has the predetermined definite dimension, the sheet size indicated in the sheet size information included in the second print job signifies that the sheet size actually selected by the user has the indefinite length, and thus the printer application 170 determines that the sheet size selected by the user through the editing application 102 has an indefinite length. When the sheet size indicated in the second print job has no predetermined definite dimension, the printer application 170 determines that the sheet size selected by the user through the editing application 102 has no indefinite length. When the printer application 170 determines that the sheet size indicated in the second print job acquired in S142 has the predetermined definite dimension associated with indefinite length (S143: YES), the process advances to step S145. When the printer application 170 determines that the sheet size has no predetermined definite dimension (S143: NO), the process advances to step S176. The process of S143 is an example of the determining whether the designated sheet size is associated with a specific sheet size having an indefinite length.

The subsequent steps S145-S165 and S170-S185 are identical to those in FIG. 4, and a description of these steps will be simplified. Unlike in the process of FIG. 4, the printer application 170 advances directly to step S170 following step S165. That is, the printer application 170 sends a transmission request to the CUPS 160 for the original print data in S150 and transmits a finalized print job to the printer 200 in S175 based on the original print data obtained in S165.

However, when the printer application 170 determined in S143 that the sheet size indicated in the received sheet size information has no indefinite dimension and thus the user-selected sheet size has no indefinite length (S143: NO), in S176 the printer application 170 transmits a finalized print job to the printer 200 based on the print data that has been obtained in S140 and replaced in S141 (the print data included in the second job). The subsequent steps S180-S185 are identical to those in FIG. 4.

In this variation, the printer application 170 executes steps S150 and S165 when the sheet size having indefinite length has been selected by the user as the size of the printing sheet. That is, the printer application 170 acquires the original print data only when the sheet size having indefinite length has been selected by the user as the size of the printing sheet and ultimately replaces the print data acquired in S140 with the original print data acquired in S165 to be used as the print data included in the finalized print job.

The printing system 1 according to this variation can reliably execute printing suitable for indefinite length printing sheet. Further, when the sheet size having indefinite length has not been selected by the user as the size of the printing sheet, the printing system 1 can ultimately use the print data acquired in S140 and converted in S141. This variation can speed up the printing process by not unnecessarily performing steps S145-S175 to replace the print data with the original print data.

### (3) Acquiring the Original Print Data Only When The Print Job Includes An Indicator Indicating That Indefinite Length Has Been Selected

This variation (3) is based on the variation (2) shown in FIG. 5. Steps in the control procedure of this variation will be described next with reference to the flowchart in FIG. 6, wherein steps similar to those of FIG. 5 described above are designated with the same step numbers to avoid duplicating description.

In the variation (2) the printer application 170 makes the determination S143 by using the predetermined definite length in the sheet size information as an indicator indicating that the sheet size actually selected by the user has the indefinite dimension. However, in this variation (3), instead of using the sheet size information, the printer application 170 makes a determination in S243 (FIG. 5), which is similar to S143, by using additional information on an indicator indicating whether the sheet size actually selected by the user has the indefinite dimension or not. The indicator may be an identifier identifying a sheet size, such as a sheet-size name, for example. The storage 115 may store additional information for distinguishing whether each identifier indicates an indefinite sheet size or a definite sheet size. The indicator may be a value of a flag indicating whether a sheet size is a definite sheet size or an indefinite sheet size.

Specifically, after S110, in S215 the editing application 102 transmits a first print job to the CUPS 160. The first print job includes an indicator as well as the print data, the sheet size information, and the job ID. As described above, the indicator is information indicating whether the sheet size actually selected by the user has the indefinite dimension or not. The indicator may be information on an identifier indicating the sheet size actually selected by the user in S105. The indicator may be a name of the sheet size. For example, when the user-selected sheet size is a definite size having no indefinite dimension, the sheet-size name may be a character string directly (explicitly) indicating the definite size, such as, “definite size”, or a character string indicating a size or type of the sheet of the definite size such as “die-cut label”, “A3”, “A4” and “letter” so as indirectly (implicitly) indicate that the sheet size is the definite size having no indefinite dimension. When the user-selected sheet size is an indefinite size having an indefinite dimension, the sheet-size name may be a character string directly (explicitly) indicating the indefinite size, such as, “indefinite size” and “continuous length”, or a character string indirectly (implicitly) indicating a size or type of the sheet of the indefinite size, such as “label sheet”. The indicator may be a predetermined specific character or a predetermined specific string character that enables the printer application 170 to identify whether the sheet size that the user has selected is an indefinite sheet size or a definite sheet size. The indicator may be a value or a flag that enables the printer application 170 to at least distinguish whether a sheet size is an indefinite sheet size or a definite sheet size.

In S120 the CUPS 160 receives the first print job transmitted in S215 from the editing application 102. The CUPS 160 extracts the print data from the first print job received in S120 and saves this print data in a suitable storage area of the storage 115. Steps S125 and S130 are identical those shown in FIG. 5.

After S130, in S235 the CUPS 160 transmits a second print job to the printer application 170. The second print job includes the indicator, such as the sheet-size name, included in the first print job received in S120, as well as the print data, the sheet size information, and the job ID. Here, the print data included in the second print job is the print data extracted in S120 when a NO determination is made in S125. However, when a YES determination is made in S125, the print data included in the second print job is the print data that has been reduced in dimensions in S130.

In S140 the printer application 170 receives the second print job transmitted in S235. Steps S141 and S142 are identical with those in FIG. 5.

After S142, in S242 the printer application 170 extracts the indicator from the received second print job.

After S242, in S243 the printer application 170 determines whether or not the indicator extracted in S242 indicates that the user selected sheet size is the indefinite sheet size having an indefinite dimension. For example, when the indicator is the sheet-size name and the sheet-size name includes a character string indicating the definite sheet size, such as “die-cut label”, “A3”, “A4” or “letter”, the printer application 170 reaches a NO determination in S245. When a NO determination is made in S243, the process advances to S176. On the other hand, when the sheet-size name includes a character string indicating the indefinite size such as “indefinite size”, for example, the printer application 170 reaches a YES determination in S243. When a YES determination is made in S243, the process advances to S145. Steps S145-S176, and S180-S185 are the same as those in FIG. 5.

In this variation, the printer application 170 executes steps S150 and S165 when the sheet size having indefinite length has been selected by the user as the size of the printing sheet. That is, the printer application 170 acquires the original print data only when the indicator indicates the sheet size having indefinite length, and replaces the print data acquired in S140 with the original print data acquired in S165 to be used as the print data included in the finalized print job.

The printing system 1 according to this variation can reliably execute printing suitable for indefinite length printing sheet. Further, when the sheet size having indefinite length has not been selected by the user as the size of the printing sheet, the printing system 1 can ultimately use the print data acquired in S140 and converted in S141 for the finalized print job. This variation can speed up the printing process by not unnecessarily performing steps S145-S175 to replace the print data with the original print data.

### (4) Other Variations

The above embodiment describes a case in which the printer application 170 is registered in the CUPS 160 as a virtual printer corresponding to the printer 200 connected to the terminal device 100, but the present disclosure is not limited to this configuration. The printer application need not be registered in the CUPS 160 as a virtual printer but may simply serve to assist or relay information for printing processes performed between the CUPS 160 and printer 200, for example. The information processing program of the present disclosure may be applied to such a printer application.

The above embodiment also describes a case in which the OS 101 possesses the CUPS 160 as an example of OS-standard printing software, but the present disclosure is not limited to this configuration. The OS 101 may possess OS-standard printing software other than CUPS, provided that the operating system includes a driverless printing function that uses the IPP protocol.

The flowcharts shown in FIGS. 2 through 6 in the above description do not limit the present invention to the steps indicated therein. Steps may be added or deleted, or their order may be rearranged, without departing from the scope and technical ideas of the invention.

In addition to what has already been described, the methods according to the embodiment and its variations described above may be used in suitable combinations.

In addition, although not illustrated individually, the present invention may be implemented with various modifications without departing from the scope of the invention.

### Hardware Configurations of the Terminal Device and Printer

Next, sample hardware configurations for the terminal device 100 and printer 200 will be described with reference to FIG. 6.

### Terminal Device

As shown in FIG. 6, the terminal device 100 has the processor 110, the storage 115, a display 140, an operating interface 150, and a communication interface 190. The processor 110, storage 115, display 140, operating interface 150, and communication interface 190 are interconnected via a bus 105 so as to be capable of exchanging data with each other.

The storage 115 is provided with a volatile storage 120 and a nonvolatile storage 130. The volatile storage 120 is DRAM, for example, and stores various programs and data used for implementing processes. The nonvolatile storage 130 is a hard disk drive or a solid state drive, for example, and has a program storage area 131 and a data storage area 132.

The program storage area 131 stores the OS 101 various programs, including a program of the OS 101, the printer application 170, the printing-related programs, and the like based on the flowcharts in FIGS. 2 through 5 described above. The data storage area 132 stores data and the like required for executing the various programs.

The processor 110 is a device that performs data processing, such as a CPU. The processor 110 executes the various programs stored in the program storage area 131. The processor 110 performs various processes including data communications with the printer 200 connected to a network NT. The processor 110 executing one of the programs stored in the program storage area 131 is an example of the processor, an example of the controller, and an example of a computer.

The display 140 is a liquid crystal display, for example, and can display various information. The operating interface 150 is a user interface, and includes a mouse and keyboard, for example, and accepts user operations. By operating the operating interface 150, the user can input various instructions into the terminal device 100.

The communication interface 190 connects to the network NT for communicating with other devices. The communication interface 190 may be a network interface, or a direct interface for directly connecting an external device, such as a USB interface. The communication interface 190 is an example of the communication interface.

The storage 115 is not limited to a configuration having the above components but may be configured of RAM, ROM, EEPROM, an HDD, a portable storage medium such as a USB memory device that is mounted in the terminal device 100, a buffer provided in the processor 110, and the like, or a combination of these components.

The storage 115 may also be a computer-readable storage medium. A computer-readable storage medium is a non-transitory medium. In addition to the above examples, non-transitory media include CD-ROM and DVD-ROM. A non-transitory medium is also a tangible medium. The same applies to a storage 215 of the printer 200 described later.

### Printer

As shown in FIG. 6, the printer 200 has a processor 210, a storage 215, a display 240, an operating interface 250, a communication interface 270, and a print engine 290. The processor 210, storage 215, display 240, operating interface 250, communication interface 270, and print engine 290 are interconnected via a bus 205 so as to be capable of exchanging data with each other.

The storage 215 is provided with a volatile storage 220 and a nonvolatile storage 230. The volatile storage 220 is DRAM, for example. The volatile storage 220 is provided with an image data storage area 222 for storing image data to be printed. The nonvolatile storage 230 is NVRAM or flash memory, for example. The nonvolatile storage 230 is provided with a program storage area 231 and a data storage area 232. The program storage area 231 stores various programs including the printing-related programs and the like in the form of firmware or the like. The data storage area 232 stores various data and the like for executing the various programs.

The processor 210 is a device that performs data processing, such as a CPU. The processor 210 executes the various programs stored in the program storage area 231.

The display 240 is a liquid crystal display, for example, and can display various information. The operating interface 250 is a user interface that is a device that accepts user operations. By operating the operating interface 250, the user can input various instructions into the printer 200. The communication interface 270 is a wired or wireless network interface for communicating with other devices. The communication interface 270 is connected to the network NT. The communication interface 270 may be a direct interface for directly connecting an external device, such as a USB interface.

The print engine 290 prints images on sheets conveyed by a conveying mechanism (not shown). The print engine 290 prints images based on print data received from the terminal device 100 or print jobs generated by the printer 200 itself in accordance with operations received through the operating interface 250. The print engine 290 may have a thermal head to print images using a thermal transfer system. However, the print engine 290 may employ a printing system other than the thermal transfer system such as such as an inkjet printing system and an electrophotographic system. The print engine 290 may be referred to as the printing member 290 or the printing assembly 290.

What is claimed is:

1. A non-transitory computer readable storage medium storing an information processing program executed by a computer included in an information processing device, the information processing device having an operating system installed thereon, the operating system having standard printing software integrated therein, wherein the standard printing software is configured to perform a modification process when a size of an original image represented by original print data exceeds a designated sheet size of a printing sheet for use in printing the original print data, wherein the modification process includes modifying the original print data to size-reduced print data representing a size-reduced image derived by reducing the size of the original image, the information processing program supporting a printer communicable with the information processing device, the information processing program, when executed by the computer, causing the information processing device to perform:
receiving specified print data from the standard printing software, the specified print data being one of the original print data and the size-reduced print data;
in response to reception of the specified print data, transmitting, to the standard printing software, a request for the original print data;
receiving the original print data from the standard printing software as a response to the request; and
transmitting, to the printer, finalized print data based on the original print data received as the response to the request.

2. The non-transitory computer readable storage medium according to claim 1, wherein the transmitting the request is performed regardless of the designated sheet size.

3. The non-transitory computer readable storage medium according to claim 1,
wherein the information processing program, when executed by the computer, causes the information processing device to further perform:
acquiring the designated sheet size; and
determining whether the size of the original image represented by the original print data exceeds the designated sheet size,
wherein the transmitting the request is performed regardless of the designated sheet size,
wherein the transmitting the finalized print data is performed when the determining determines that the size of the original image represented by the original print data exceeds the designated sheet size.

4. The non-transitory computer readable storage medium according to claim 3,
wherein the information processing program, when executed by the computer, causes the information processing device to further perform:
when the determining determines that the size of the original image represented by the original print data is less than or equal to the designated sheet size, transmitting, to the printer, second finalized print data based on the specified print data,
wherein the transmitting the finalized print data is not performed when the determining determines that the size of the original image represented by the original print data is less than or equal to the designated sheet size.

5. The non-transitory computer readable storage medium according to claim 1,
wherein the information processing program, when executed by the computer, causes the information processing device to further perform:
acquiring the designated sheet size; and
determining whether the designated sheet size is associated with a specific sheet size having an indefinite length,
wherein the transmitting the request is performed when the determining determines that the designated sheet size is associated with the specific sheet size.

6. The non-transitory computer readable storage medium according to claim 5,
wherein the information processing program, when executed by the computer, causes the information processing device to further perform:
when the determining determines that the designated sheet size is not associated with the specific sheet size, transmitting, to the printer, second finalized print data based on the specified print data,
wherein the transmitting the finalized print data is not performed when the determining determines that the designated sheet size is not associated with the specific sheet size.

7. The non-transitory computer readable storage medium according to claim 5,
wherein the transmitting the request is not performed when the determining determines that the designated sheet size is not associated with the specific sheet size.

8. The non-transitory computer readable storage medium according to claim 1,
wherein the information processing program is registered as a virtual printer in the standard printing software so that the standard printing software can transmit the original print data and the size-reduced print data to the information processing program.

9. The non-transitory computer readable storage medium according to claim 1,
wherein the finalized print data is for use in printing an image on the printing sheet of a continuous length sheet wound in a roll to create a label.

10. The non-transitory computer readable storage medium according to claim 1,
wherein the finalized print data represents a finalized image having the same size as the original image.

11. The non-transitory computer readable storage medium according to claim 1,
wherein the information processing program, when executed by the computer, causes the information processing device to further perform:
acquiring an indicator indicating whether a user selected sheet size includes an indefinite dimension; and
determining whether the indicator indicates that the user selected sheet size includes the indefinite dimension,
wherein the transmitting the request is performed when the determining determines that the indicator indicates that the user selected sheet size includes the indefinite dimension.

12. An information processing device comprising:
a communication interface communicable with a printer;
a storage; and
a processor;
wherein an information processing program supporting the printer and stored in the storage, when executed by the processor, causes the processor to perform:
receiving specified print data from a standard printing software, the standard printing software integrated in an operating system installed on the information processing device, wherein the standard printing software is configured to perform a modification process when a size of an original image represented by original print data exceeds a designated sheet size of a printing sheet for use in printing the original print data, wherein the modification process includes modifying the original print data to size-reduced print data representing a size-reduced image derived by reducing the size of the original image, the specified print data being one of the original print data and the size-reduced print data;
in response to reception of the specified print data, transmitting, to the standard printing software, a request for the original print data;
receiving the original print data from the standard printing software as a response to the request; and
transmitting, to the printer through the communication interface, finalized print data based on the original print data received as the response to the request.
